(19) United States
(12) Patent Application Publication
(10) Pub. No.: US 2012/0330717 A1
(43) Pub. Date: Dec. 27, 2012

(54) RETAIL FORECASTING USING PARAMETER ESTIMATION

(75) Inventors: Shivaram SUBRAMANIAN, Eddington, ME (US); Bharath Kumar KRISHNAN, Lexington, MA (US)

(73) Assignee: ORACLE INTERNATIONAL CORPORATION, Redwood Shores, CA (US)

(21) Appl. No.: 13/168,382

(22) Filed: Jun. 24, 2011

(51) Int. Cl. G06Q 10/00

(52) U.S. Cl. 705/7.31

(57) ABSTRACT

A system generates a parameter estimation of a plurality of variables. The system receives input data that includes user acceptance criteria and user objectives. The system encodes the input data into a matrix and transforms the input data using a dual linear program. The system then solves the dual linear program using a dual simplex method with boxed variables, and recovers parameter values for the parameter estimation. The parameter estimation may be used to provide retail forecasting.

### FIELD

One embodiment is directed generally to a computer system, and in particular to a retail forecasting computer system that uses parameter estimation.

### BACKGROUND INFORMATION

Parameter estimation provides for the efficient use and analysis of data to aid in mathematically modeling phenomena and the estimation of constants appearing in these models. Much of parameter estimation can be related to four optimization problems: (1) criterion: the choice of the best function to optimize (minimize or maximize); (2) estimation: the optimization of the chosen function; (3) design: optimal design to obtain the best parameter estimates; and (4) modeling: the determination of the mathematical model which best describes the system from which data are measured.

Parameter estimation methods typically use the technique of linear regression, also known as “ordinary least-squares” (“OLS”). However, such methods are known to not be “robust” in that they can be vulnerable to outliers in data. The addition of a single outlying data point can significantly affect the value of the estimated parameters.

### SUMMARY

One embodiment is a system that generates a parameter estimation of a plurality of variables. The system receives input data that includes user acceptance criteria and user objectives. The system encodes the input data into a matrix and transforms the input data using a dual linear program. The system then solves the dual linear program using a dual simplex method with boxed variables, and recovers parameter values for the parameter estimation. The parameter estimation may be used to provide retail forecasting.

### BRIEF DESCRIPTION OF THE DRAWINGS

FIG. 1 is a block diagram of a computer system that can implement an embodiment of the present invention.

FIG. 2 is a flow diagram of the functionality of the retail parameter estimation module of FIG. 1 when generating retail parameter estimation in accordance with one embodiment.

### DETAILED DESCRIPTION

One embodiment is a computer system for retail modeling and forecasting using parameter estimation. The system stores input data in a dense matrix format such as a floating point array, creates additional temporary arrays to represent an appropriate dual formulation, and solves the resultant specially structured dual linear program using a revised dual simplex method for boxed-variables to the desired level of optimality. The result is parameter values that are used for retail modeling and forecasting.

Parameter estimation methods can be used for retail forecasting. For example, methods can be used for determining the price elasticity of demand for a consumer product, such as if the price of a shirt is reduced 20%, how much will sales increase. Some known parameter estimation methods, such as linear regression, also known as “ordinary least-squares” (“OLS”), as discussed above, is vulnerable to outliers in data. Other known methods include “maximum likelihood estimation” (“MLE”).

Further, the incorporation of user-acceptance constraints (for example, when calibrating a retail model to predict sales due to promotions, a user might reasonably expect that the model will predict that deeper discounts lead to higher sales, or a front page advertisement will drive more sales compared to an advertisement in the inside pages of a newspaper), makes the problem much harder to solve. Some prior art solutions merely discard such models that do not meet the user acceptance criteria. However, this leads to increased forecasting error.

In addition, commercial solvers typically optimize only a single metric relating to “goodness of fit”, even though a user may look at multiple criteria. For example, a user might be interested in minimizing forecast error for a set of forecasts while making sure that no single forecast has an error greater than a set threshold.

Linear programming (“LP”) has been used for parameter estimation problems because it has been shown to generate robust answers that are relatively immune to data outliers. LP also allows the specification of user-acceptance constraints. However, even the most scalable known LP implementations are too compute-intensive and have not proven to be fully practical, especially when applied to a direct/native LP encoding of such parameter estimation problems involving a large amount of data.

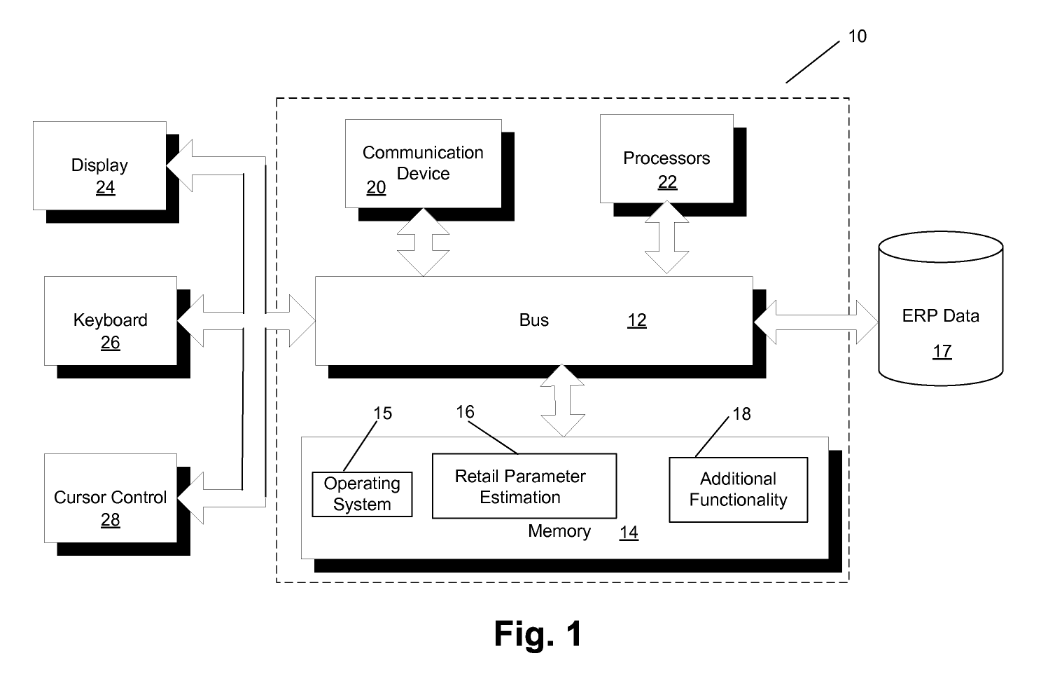

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a retail parameter estimation module 16 that uses parameter estimation to price, forecast and model retail sales, as disclosed in more detail below. System 10 can be part of a larger system, such as an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing information, inventory information, etc.

### Input Data

One embodiment uses the following input data/notation:
m=number of parameters to be simultaneously estimated for the predictive model (i=1, . . . , m), where m is typically no more than 30;
n=number of historical observations for the coefficients for each of these m parameters (j=1, . . . , n), where n is typically very large (1,000,000 observations or more);
a′ᵢⱼ=observed coefficient for parameter i in observation j;
sᵢ=user-acceptable sign constraint for parameter i (this requires parameter i to take a value that is either non-negative or non-positive);
(Iᵢ, uᵢ)=upper and lower bound for the value of parameter i;
wⱼ=relative weight (importance) of observation j;
bⱼ=RHS value of dependent variable (target) in observation j, e.g. sales lift, weekly sales rate, etc.;
αᵢ=penalty on the parameter value i, (to ensure that parameters that will have little predictive power are turned off);
uacₖ=k^{th} user-acceptance constraint that imposes a joint (combined) restriction on the weighted sum of more than one parameter value. This constraint is represented as follows:
Σᵢdᵢₖ*valᵢ≧eₖ, where, leading to the following output data:
(Output Data) valᵢ=value of parameter i (decision variable whose value is to be determined analytically) that satisfies all user acceptance constraints while minimizing the sum of absolute errors between predicted and observed values for the dependent variable, across all observations.

A traditional approach to solve the above is to use the ordinary least-squares approach (“OLS”) that minimizes the sum of squared errors given by Min Σⱼ(bⱼ−Σⱼaᵢⱼ*valᵢ)². However, in the presence of sign constraints and other user-acceptance constraints, OLS fails. A quadratic programming (“QP”) problem has to be solved, which tends to fail practical performance and response requirements for large n, and may not be a robust estimator in many situations where the distribution of the errors does not resemble a bell curve, and a presence of a few significant but skewed observations of the dependent variable (or target) may cloud the practical predictive power of the resultant model.

An alternative in such situations that tends to avoid these above problems is the linear programming (“LP”) approach. In particular, the LP approach that minimizes the sum of absolute deviations can be a robust estimator of the sample median. However, this approach has various drawbacks, such as:
The error-minimization functional form in a LP is non-differentiable and non-smooth, and thus impacts performance requirements.
Solving large LPs typically requires investment in so-called sparse commercial LP solvers (e.g., the IBM ILOG CPLEX Optimizer from IBM Corp., or Gurobi Optimization from Gurobi Corp.).
Even with good commercial solvers such as those described above, performance can be poor if the right mathematical model is not provided as input (there are several alternatives).

Embodiments of the present invention utilize efficient LP formulations for parameter estimation derived via a three-step sequence of transformations. Embodiments further use novel metrics and user-acceptance requirements in the form of a variety of user-acceptance constraints and error-minimization objectives. Embodiments exploit the special structure of the resulting LP formations to significantly improve practical convergence. Further, embodiments use a triplet data structure in combination with a quick-sort subroutine that speeds up empirical convergence of the solution approach.

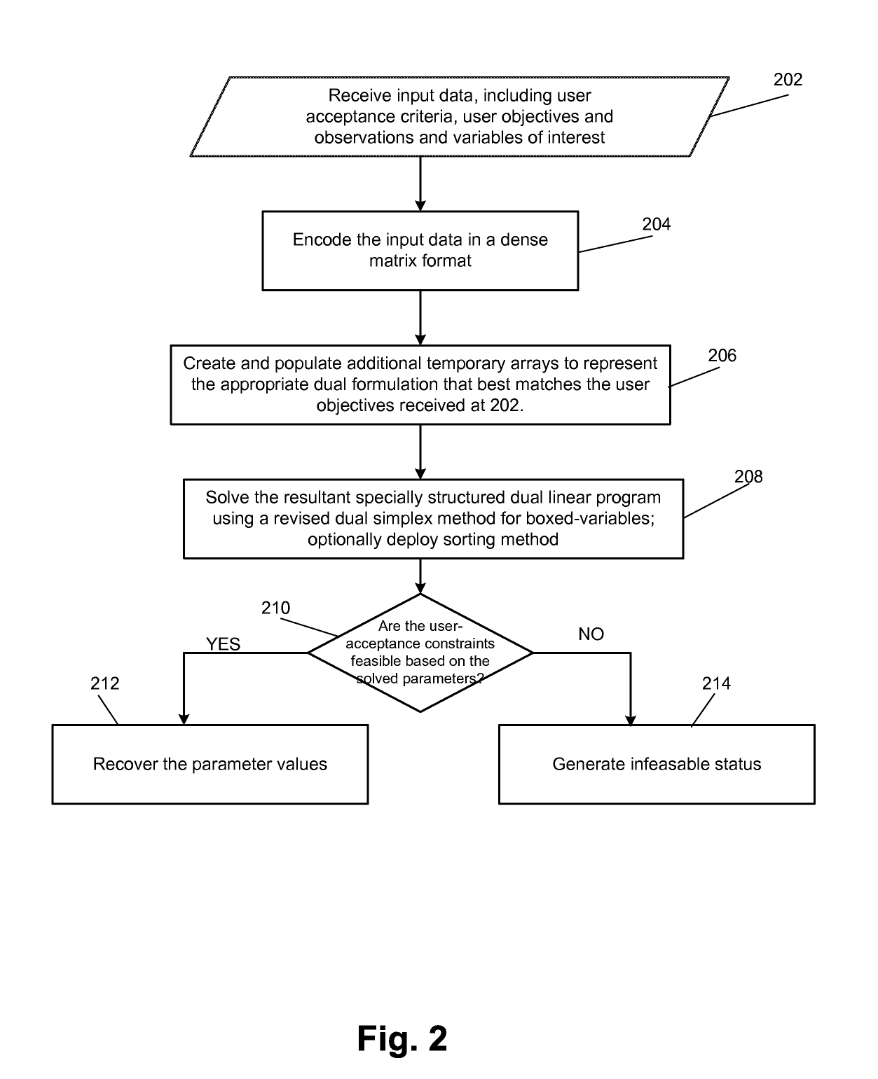

FIG. 2 is a flow diagram of the functionality of retail parameter estimation module 16 of FIG. 1 when generating retail parameter estimation in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, input data is received, including user acceptance criteria, user objectives and observations and variables of interest. The user acceptance criteria may include the user's intuition on how the model should behave, and hard constraints (e.g., price cuts should never lead to decreased sales) and soft constraints (e.g., front page advertisements tend to do worse than back page advertisements).

The input data at 202 can be in the following form in one embodiment:
A regressor coefficient matrix (i.e., a floating point two-dimensional array whose elements represents elements a′[ ] [ ]). This input is typically in sparse form (i.e., no non-zero elements and their positions are provided).
Observed values of the dependent variables (b[ ]) in sparse or dense form.
User-acceptance constraints, provided in the parameterized form using a combination of Boolean values, integer and floating-point numerical data (sign constraints, inter-parameter constraints, desired bias to reduce the number of active parameters), and numerical tolerance parameters.
Desired error-minimization objective: minimize sum of absolute deviations, minimize maximum deviation, or minimize a combination of the two objectives.

At 204, the input data is encoded in a dense matrix format (i.e., using standard floating-point arrays).

At 206, additional temporary arrays are created and populated to represent the appropriate dual variable LP formulation (DP, DP2, or DP3, disclosed in detail below), that best matches the user objectives received at 202.

At 208, the resultant specially structured dual linear program is solved using a revised dual simplex method for boxed-variables disclosed below to the desired level of optimality. In one embodiment, a sorting method to induce rapid convergence for this structure is also deployed.

At 210, it is determined if the user-acceptance constraints are feasible based on the solved parameters. If the user-acceptance constraints are feasible at 210, at 212 the parameter values are recovered from the optimal dual values in the optimal solution determined at 206. Otherwise, no solution is returned, and an infeasible status is generated at 214.

### Mathematical Transformations

In one embodiment, a standard LP formulation is transformed via a three step transformation to generate one of three novel dual LP formulations (referred to as “DP”, “DP2” or “DP3”). As disclosed in conjunction with 206 in FIG. 2 above, the input data is applied to the LP formulations to generate outputs.

Transformation Step 1: Original LP Formulation (Minimizing weighted sum of least absolute deviations):
Define valᵢ=decision variable yᵢ

$$LAD \text{:} Minimize {\sum }_{j = 1}^{n} {w}_{i} \vert {b}_{i} {\sum }_{i = 1}^{m} {a}_{ij}^{′} {y}_{i} \vert$$

subject to:

$${\sum }_{i = 1}^{m} {d}_{ik}^{′} {y}_{i} \geq {e}_{k} ∀ k = 1 , … , K$$

$${y}_{i} \geq 0 ∀ i ∈ {s}^{+}$$

$${y}_{i} \leq 0 ∀ i ∈ {s}^{-}$$

Transformation 1: Convert to a Linear Program:
Define xᵢ=yᵢ, aᵢⱼ=a′ᵢⱼ, dᵢₖ=d′ᵢₖ∀ i ∈ s⁺
Define xᵢ=−yᵢ, aᵢⱼ=−a′ᵢⱼ, dᵢₖ=−d′ᵢₖ∀ i ∈ s⁻
   The resultant LP can be shown be equivalent to the following problem LP:

$$LP \text{:} Minimize {\sum }_{j = 1}^{n} {w}_{j} ( {z}_{j}^{+} + {z}_{j}^{-} ) + {\sum }_{i = 1}^{m} {α}_{i} {x}_{i}$$

subject to:

$${\sum }_{i = 1}^{m} {a}_{ij} {x}_{i} + {z}_{j}^{+} - {z}_{j}^{-} = {b}_{j} , j = 1 , … , n$$

$${\sum }_{i = 1}^{m} {d}_{ik} {x}_{i} \geq {e}_{k} ∀ k = 1 , … , K$$

$${x}_{i} \geq 0$$

Problem “LP” can be solved directly by a commercial LP solver. The optimal values obtained for x can re-mapped to y to produced the required output set val. However, for a large n, the number of rows and columns in LP is of the order of a few million. Consequently, even commercial software packages such as CPLEX require a relatively inordinate amount of time to solve this problem. To obtain a more efficient formulation, one embodiment uses the theory of duality to generate the dual formulation to this problem as disclosed below.

Transformation 2: Compute an Equivalent LP Using Duality Theory to Generate “DP”:

$$DP \text{:} Maximize {\sum }_{j = 1}^{n} {b}_{j} {π}_{j} + {\sum }_{k = 1}^{K} {e}_{k} {λ}_{k}$$

subject to:

$${\sum }_{j = 1}^{n} {a}_{ij} {π}_{j} + {\sum }_{k = 1}^{K} {d}_{ik} {λ}_{k} \leq {α}_{i} , i = 1 , … , m \\ - {w}_{j} \leq {π}_{j} \leq {w}_{j}$$

$${λ}_{k} \geq 0$$

For DP, the following applies:
a) A simplex-tableau method based LP solution approach as part of its output generates two sets of answers:
   The primal variable values
   The dual variable values
b) The optimal dual variable values that are obtained as part of the optimal simplex tableau for DP gives back the optimal value for x.
c) DP has a small number (m) of constraints and a large number of (n) columns via the decision variables πᵢ.
d) The upper and lower bounds (−w, w) on the π-variables are handled implicitly via the solution approach as ‘boxed variables’.

### Solution Method for DP

One embodiment solves such parameter estimation problems that are characterized by novel user-acceptance constraints and novel user-specified business objectives. This solution is achieved by recognizing the hidden practical implications of the mathematical properties of the novel transformations in the context of parameter estimation and then finding the best available approach, and, if desired, suitably modifying it via novel enhancements to speed it up.

One embodiment recognizes the fact that DP has a small number of rows. Therefore, a revised simplex method can be used to solve this problem. Since the number of rows is small, it allows a small working basis to be employed that is defined by an m×m square matrix. Since the working basis is small, simple and direct arithmetic operations can be performed to obtain the inverse of that matrix and other row and column operations required in a simplex implementation, without requiring sophisticated libraries. Therefore, even though the original primal problem includes millions of rows and columns, embodiments adopt a far simpler dense-matrix approach as opposed to the far more sophisticated sparse-matrix methods employed in commercial packages, which requires either a massive amount of incremental expense to purchase, or significant engineering work to complete (e.g., a factor of 20 more effort).

Embodiments use the dual simplex method. The dual simplex method is an instance of a simple method for linear program where dual feasibility is always maintained. Therefore, embodiments satisfy most of the user-acceptance constraints at every intermediate step of the method.

Since embodiments also have to handle the boxed variables (π) without increasing the size of the working basis, embodiments implicitly perform these calculations. At least (n−m) of the boxed variables can take only one of two possible values—they will be either at their upper (w) or lower bounds (−w) in an optimal solution. For example, if there are a million observations (=number of boxed variables) and 10 parameters to estimate, at least 999,990 boxed variables will be at their upper or lower bounds. Thus, a solution method that efficiently exploits this feature will converge significantly faster.

Embodiments combine the concepts of the disclosed DP linear programming formulation, the revised simplex implementation, the dual simplex method, and efficient and implicit box-variable handling. This combined approach utilizes a simple version of the revised dual-simplex method with box-variables (“RDSM-BV”) that will converge quickly. In one embodiment, the known “long-step” approach (disclosed in, for example, Koberstein, A., “Progress in the dual simplex algorithm for solving large scale LP problems: techniques for a fast and stable implementation”, Journal of Computational Optimization and Applications 41 (2), 2008) is modified.

[0038]The long-step approach admits an efficient calculation of the bulk of the boxed variables. One key step in the long-step algorithm for RDSM-BV is to compute a score for each boxed-variable. This allows embodiments to decide whether a box-variable will be retained at its current value, moved to its upper bound (w), or moved to its lower bound (−w).

Embodiments speed up the basic long-step algorithm by adopting as an intermediate step a specialized triplet data structure for improving efficiency, and a quick-sort algorithm based on an array of these triplets for improving effectiveness for parameter estimation problems. This triplet-quick sort combination is utilized to efficiently compute the most effective order of box-variables such that it empirically maximizes the number of bound swaps for the class of parameter estimation problems addressed.

### The Long-Step Technique for the Revised Dual Simplex Method with Boxed Variables

Embodiments use a novel modification of the general steps of the algorithm disclosed in Koberstein, A. “The Dual Simplex Method, Techniques for a fast and stable implementation”, PhD Dissertation, Paderborn, Germany, 2005, Chapter 3, Algorithms 4-7, the disclosure of which is herein incorporated by reference. In contrast to these prior art methods/algorithms disclosed in Koberstein, embodiments implement a bound-flip ratio test step (“BFRT”) to speed up the class of problems directed to retail forecasting/modeling. Given the unusually large number of boxed-variables in the resultant mathematical formulation, the embodiments focus strongly on efficiently maximizing the number of bounds that can be flipped at every step of the dual simplex implementation, rather than achieve the maximum improvement in the objective function value.

[0041]Embodiments create and store an array (referred to as “RCvars”) of triplets (i.e., record three coefficients) for each non-basic variable whose bounds can be flipped from its lower to its upper bound or vice-versa. The three coefficients are stored as shown below:
Coefficient 1: +k or −k, where k is the non-basic variable index. If the non-basic variable is currently at its lower bound, −k, and +k are stored otherwise.
Coefficient 2: Ratio[k]=The ratio of the reduced cost of the variable to its modified pivot value given by \tilde{B}⁻¹ aₖ.
Coefficient 3: Slope[k]=A potential improvement value for the non-basic variable that is given by the difference between the upper and lower bounds, which is further scaled by the absolute value of the unmodified pivot value given by |B⁻¹aₖ|.

A tolerance value of 10⁻⁶ is used. The resultant calculations are shown below in the form of a pseudo code:

PART 1: Method for Bound-Flip Candidate Selection
Input: Current Working Basis B and corresponding simplex tableau based on the revised dual simplex method.
Do: For all Non-basic variables:

### Step 1: Feasibility Test:

If (any non-basic variable is at its lower bound (LB) and it's reduced cost (rc) value <−tolerance) OR

(nb var at upper bound (UB) and rc>tolerance)
Solution does not exist, so stop and exit the overall routine.

### Step 2: Check if var at LB can be Improved by Flipping to its UB

If nb var is at LB and \tilde{B}⁻¹aₖ>tolerance:

Compute Ratio[k]=rc[col]/\tilde{B}⁻¹aᵣ(k)

Compute Slope[k]=(u[col]−I[col])*|\tilde{B}⁻¹aₖ|;

Create new Triplet (−k, ratio[k], slope[k]) and add to RCvars

### Step 3: Check if Var at UB can be Improved by Flipping to its LB

If nb var is at UB and \tilde{B}⁻¹aₖ<−tolerance:

Compute Ratio[k]=rc[col]/\tilde{B}⁻¹aᵣ(k)

Compute Slope[k]=(u[col]−I[col])*|\tilde{B}¹aₖ|

Create new Triplet (+k, ratio[k], slope[k]) and add to RCvars

### End Iterations

Step 4: Employ any standard sorting algorithm (e.g., the built-in quick-sort algorithm available in “Java” from Oracle Corp.) to sort the triplets stored in RCvars in ascending order (increasing values) of their ratios (coefficient 2). By doing this, the smallest ratios are processed earlier, which in turn flips a maximal number of bounds as can be seen below. Further, the use of this particular triplet structure allows the efficient retrieval of all the relevant information required directly from runtime-memory, without the need to perform additional computations or recalculations.

### Output: Reordered (Sorted) Triplets in RCvars Array

PART 2: Method to Compute the Set of Variables Whose Bounds Will be Flipped in the Current Dual Simplex Iteration

The values are flipped from their lower to upper bounds (or vice versa) in the sorted order as shown below.
Input: Reordered RCvars array, simplex tableau, and the current value for an algorithm parameter Δₗᵤ that are used for initialization.

### Step 1: Initialization

Set j=0

Assign first_triplet=zero-th (first) entry in RCvars

Initialize current_slope=|Δₗᵤ|−slope of first_triplet

### Initialize Number_of_flips=0;

### Step 2: Bound Flipping

Do while (j+1)<size of RCvars AND current_slope is non-negative:

a. Reduce the value of current_slope by the slope of the (j+1)^{th} triplet in RCvars

b. j=j+1

### End Iterations for Step 2

Output=j. This indicates that the first j elements of the variables in the sorted RCvars array can have their bounds flipped from lower to their upper bound or vice versa (the first coefficient indicates which of these two situations apply).

As can be observed in step (2a), the smaller the reduction in the current_slope, the lesser the possibility of it becoming negative (thereby terminating the iterations). In practice, it is observed that 75-90% of the boxed variables are flipped in any single long step iteration, which greatly speeds up convergence, and in the end, no more than 10-15 iterations of the dual simplex method are required before optimality is reached. Embodiments employ a novel specific triplet structure to record candidate data in conjunction with the reordering technique of the candidates and subsequent retrieval of the results.

### Alternative User-Specified Objectives (DP2, DP3)

DP2: Minimizing maximum error in predicted versus observed value of dependent variable (target) among all observations (i.e., minimizing error on worst-case prediction).

$$LP 2 \text{:} Minimize Pz + {\sum }_{i = 1}^{m} {α}_{i} {x}_{i}$$

subject to:

$$z - {\sum }_{i = 1}^{m} {a}_{ij} {x}_{i} \geq - {b}_{j} , j = 1 , … , n$$

$$z + {\sum }_{i = 1}^{m} {a}_{ij} {x}_{i} \geq {b}_{j} , j = 1 , … , n$$

$${\sum }_{i = 1}^{m} {d}_{ik} {x}_{i} \geq {e}_{k} ∀ k = 1 , … , K$$

$${x}_{i} \geq 0 , z \geq 0.$$

Embodiments use the following novel dual formulation (DP2):

$$DP 2 \text{:} Maximize {\sum }_{j = 1}^{n} {b}_{j} ( {π}_{j}^{+} - {π}_{j}^{-} ) + {\sum }_{k = 1}^{K} {e}_{k} {λ}_{k}$$

subject to:

$${\sum }_{j = 1}^{n} {a}_{ij} ( {π}_{j}^{+} - {π}_{j}^{-} ) + {\sum }_{k = 1}^{K} {d}_{ik} {λ}_{k} \leq {α}_{i} , ∀ i = 1 , … , m$$

$${\sum }_{j = 1}^{n} ( {π}_{j}^{+} + {π}_{j}^{-} ) \leq P . \\ {λ}_{k} \geq 0 , {π}^{+} \geq 0 , {π}^{-} \geq 0$$

The simplex tableau of this equivalent formulation DP2 has (2n+K) columns, but only (m+1) rows. Although there are no obvious boxed-variables present in this formulation, the disclosed approach (based on a simple dense matrix technique) can still be used. Note that at least (2n+K−m−1) variables in this problem will be zero by linear programming theory. Therefore, embodiments that use DP2 converge relatively quickly in practice. Further, sufficiently large (heuristic) upper bounds on the dual variables (π) can be used to regain the box-variable structure, which further helps speed up the solution procedure in practice.

Assume the optimal value for the decision variable z (that is recovered as the optimal dual variable to the constraint that bounds the sum of the dual variables to unity) is z*. This value represents the smallest possible (maximum deviation) error among all observations. One goal would be to minimize the sum of absolute errors while also limiting this minimal maximum deviation. This additional user acceptance requirement can be added by adding upper bounds (w) on the dual variables (π⁺, π⁻) and solving the resultant dual LP formulation shown below (i.e., “DP3”).

DP3: Minimizing sum of absolute deviations while also limiting the maximum error among all observations.

$$DP 3 \text{:} Maximize {\sum }_{j = 1}^{n} {b}_{j} ( {π}_{j}^{+} - {π}_{j}^{-} ) + {\sum }_{k = 1}^{K} {e}_{k} {λ}_{k}$$

subject to:

$${\sum }_{j = 1}^{n} {a}_{ij} ( {π}_{j}^{+} - {π}_{j}^{-} ) + {\sum }_{k = 1}^{K} {d}_{ik} {λ}_{k} \leq {α}_{i} , ∀ i = 1 , … , m$$

$${\sum }_{j = 1}^{n} ( {π}_{j}^{+} + {π}_{j}^{-} ) \leq 1$$

$${π}_{j}^{+} \leq {w}_{j} , ∀ j = 1 , … , n . \\ {π}_{j}^{-} \leq {w}_{j} , ∀ j = 1 , … , n . \\ {λ}_{k} \geq 0 , {π}^{+} \geq 0 , {π}^{-} \geq 0$$

Additional user-acceptance constraints that can be handled by embodiments include user-imposed lower and upper bounds on parameter values, and a penalty on an absolute deviation from a user-preferred (desired) input parameter value. These constraints are handled using data transformation techniques to convert the constraints to an equivalent lower and upper bounds requirement.

As disclosed, embodiments include a series of mathematical transformations to generate an LP formulation for a parameter estimation problem. The LP formulation can be used to estimate parameters for a forecasting model that predicts retail sales resulting from a promotional offer, but can also be used outside of the retail environment.

The LP formulations in accordance to embodiments have a special structure that admits a scalable algorithm implementation for robust estimation of parameters while satisfying user-acceptance constraints/requirements and has the further benefit that they converge rapidly in practice. The LP formulations allow for the simultaneous consideration of multiple “goodness of fit” metrics while estimating parameters. Specifically, the average absolute deviation can be minimized while also limiting the maximum absolute deviation with a user-specified value. In one embodiment, the user-acceptance requirements are fully integrated into the parameter estimation mathematical formulation and optimized using single call to the LP solver. Therefore, there is no need to sequentially perform parameter estimation, check whether the solution satisfies the user-acceptance requirements, adjust the parameters, re-estimate, etc., as is required with some prior art solutions

Embodiments allows advanced modeling tasks such as variable selection (selecting the best sub-set of variables from among a collection of potential factors) and hierarchical smoothing of estimates (making sure that the sales response to price changes for diet-cola is not drastically different from the sales response to price changes that all cola drinks exhibit). Even for large volumes of data, embodiments consume a limited amount of memory and empirical performance increases only modestly with an increase in the volume of data used for the estimation in one embodiment through the use of a key sorting step in the dual simplex implementation.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, causes the processor to perform parameter estimation of a plurality of variables, the instructions comprising:
receive input data comprising user acceptance criteria and user objectives;
encode the input data into a matrix;
transform the input data using a dual linear program;
solve the dual linear program using a dual simplex method with boxed variables; and
recover parameter values for the parameter estimation.

2. The computer readable medium of claim 1, wherein the dual linear program comprises:
$$DP \text{:} Maximize {\sum }_{j = 1}^{n} {b}_{j} {π}_{j} + {\sum }_{k = 1}^{K} {e}_{k} {λ}_{k}$$
subject to:
$${\sum }_{j = 1}^{n} {a}_{ij} {π}_{j} + {\sum }_{k = 1}^{K} {d}_{ik} {λ}_{k} \leq {α}_{i} , i = 1 , … , m \\ - {w}_{j} \leq {π}_{j} \leq {w}_{j}$$
$${λ}_{k} \geq 0.$$

3. The computer readable medium of claim 1, wherein the dual linear program comprises:
$$DP 2 \text{:} Maximize {\sum }_{j = 1}^{n} {b}_{j} ( {π}_{j}^{+} - {π}_{j}^{-} ) + {\sum }_{k = 1}^{K} {e}_{k} {λ}_{k}$$
subject to:
$${\sum }_{j = 1}^{n} {a}_{ij} ( {π}_{j}^{+} - {π}_{j}^{-} ) + {\sum }_{k = 1}^{K} {d}_{ik} {λ}_{k} \leq {α}_{i} , ∀ i = 1 , … , m$$
$${\sum }_{j = 1}^{n} ( {π}_{j}^{+} + {π}_{j}^{-} ) \leq P . \\ {λ}_{k} \geq 0 , {π}^{+} \geq 0 , {π}^{-} \geq 0.$$

4. The computer readable medium of claim 1, wherein the dual linear program comprises:
$$DP 3 \text{:} Maximize {\sum }_{j = 1}^{n} {b}_{j} ( {π}_{j}^{+} - {π}_{j}^{-} ) + {\sum }_{k = 1}^{K} {e}_{k} {λ}_{k}$$
subject to:
$${\sum }_{j = 1}^{n} {a}_{ij} ( {π}_{j}^{+} - {π}_{j}^{-} ) + {\sum }_{k = 1}^{K} {d}_{ik} {λ}_{k} \leq {α}_{i} , ∀ i = 1 , … , m$$
$${\sum }_{j = 1}^{n} ( {π}_{j}^{+} + {π}_{j}^{-} ) \leq 1$$
$${π}_{j}^{+} \leq {w}_{j} , ∀ j = 1 , … , n . \\ {π}_{j}^{-} \leq {w}_{j} , ∀ j = 1 , … , n . \\ {λ}_{k} \geq 0 , {π}^{+} \geq 0 , {π}^{-} \geq 0.$$

5. The computer readable medium of claim 1, wherein the matrix is a dense form.

6. The computer readable medium of claim 1, further comprising:
generate an array of triplet coefficients for each variable that can be flipped from a lower bound to an upper bound or from the upper bound to the lower bound; and
sort the triplet coefficients in ascending order of ratios.

7. The computer readable medium of claim 1, where the solve the dual linear program generates primal variable values and dual variable values.

8. The computer readable medium of claim 1, wherein the parameter estimation provides a retail forecast.

9. A computer implemented method of parameter estimation of a plurality of variables, the method comprising:
receiving input data comprising user acceptance requirements and user objectives;
encoding the input data into a matrix;
transforming the input data using a dual linear program;
solving the dual linear program using a dual simplex method with boxed variables; and
recovering parameter values for the parameter estimation.

10. The computer implemented method of claim 9, wherein the dual linear program comprises:
$$DP \text{:} Maximize {\sum }_{j = 1}^{n} {b}_{j} {π}_{j} + {\sum }_{k = 1}^{K} {e}_{k} {λ}_{k}$$
subject to:
$${\sum }_{j = 1}^{n} {a}_{ij} {π}_{j} + {\sum }_{k = 1}^{K} {d}_{ik} {λ}_{k} \leq {α}_{i} , i = 1 , … , m \\ - {w}_{j} \leq {π}_{j} \leq {w}_{j}$$
$${λ}_{k} \geq 0.$$

11. The computer implemented method of claim 9, wherein the dual linear program comprises:
$$DP 2 \text{:} Maximize {\sum }_{j = 1}^{n} {b}_{j} ( {π}_{j}^{+} - {π}_{j}^{-} ) + {\sum }_{k = 1}^{K} {e}_{k} {λ}_{k}$$
subject to:
$${\sum }_{j = 1}^{n} {a}_{ij} ( {π}_{j}^{+} - {π}_{j}^{-} ) + {\sum }_{k = 1}^{K} {d}_{ik} {λ}_{k} \leq {α}_{i} , ∀ i = 1 , … , m$$
$${\sum }_{j = 1}^{n} ( {π}_{j}^{+} + {π}_{j}^{-} ) \leq P . \\ {λ}_{k} \geq 0 , {π}^{+} \geq 0 , {π}^{-} \geq 0.$$

12. The computer implemented method of claim 9, wherein the dual linear program comprises:
$$DP 3 \text{:} Maximize {\sum }_{j = 1}^{n} {b}_{j} ( {π}_{j}^{+} - {π}_{j}^{-} ) + {\sum }_{k = 1}^{K} {e}_{k} {λ}_{k}$$
subject to:
$${\sum }_{j = 1}^{n} {a}_{ij} ( {π}_{j}^{+} - {π}_{j}^{-} ) + {\sum }_{k = 1}^{K} {d}_{ik} {λ}_{k} \leq {α}_{i} , ∀ i = 1 , … , m$$
$${\sum }_{j = 1}^{n} ( {π}_{j}^{+} + {π}_{j}^{-} ) \leq 1$$
$${π}_{j}^{+} \leq {w}_{j} , ∀ j = 1 , … , n . \\ {π}_{j}^{-} \leq {w}_{j} , ∀ j = 1 , … , n . \\ {λ}_{k} \geq 0 , {π}^{+} \geq 0 , {π}^{-} \geq 0.$$

13. The computer implemented method of claim 9, wherein the matrix is a dense form.

14. The computer implemented method of claim 9, further comprising:
generating an array of triplet coefficients for each variable that can be flipped from a lower bound to an upper bound or from the upper bound to the lower bound; and
sorting the triplet coefficients in ascending order of ratios.

15. The computer implemented method of claim 9, where the solving the dual linear program generates primal variable values and dual variable values.

16. The computer implemented method of claim 9, wherein the parameter estimation provides a retail forecast.

17. A retail forecasting system comprising:
a processor;
a computer readable medium coupled to the processor and storing instructions;
wherein the instructions, when executed by the processor, comprise:
receiving input data comprising user acceptance criteria and user objectives;
encoding the input data into a matrix;
transforming the input data using a dual linear program;
solving the dual linear program using a dual simplex method with boxed variables; and
recovering parameter values for the parameter estimation, the parameter values comprising a retail forecast.

18. The system of claim 17, wherein the dual linear program comprises:
$$DP \text{:} Maximize {\sum }_{j = 1}^{n} {b}_{j} {π}_{j} + {\sum }_{k = 1}^{K} {e}_{k} {λ}_{k}$$
subject to:
$${\sum }_{j = 1}^{n} {a}_{ij} {π}_{j} + {\sum }_{k = 1}^{K} {d}_{ik} {λ}_{k} \leq {α}_{i} , i = 1 , … , m \\ - {w}_{j} \leq {π}_{j} \leq {w}_{j}$$
$${λ}_{k} \geq 0.$$

19. The system of claim 17, wherein the dual linear program comprises:
$$DP 2 \text{:} Maximize {\sum }_{j = 1}^{n} {b}_{j} ( {π}_{j}^{+} - {π}_{j}^{-} ) + {\sum }_{k = 1}^{K} {e}_{k} {λ}_{k}$$
subject to:
$${\sum }_{j = 1}^{n} {a}_{ij} ( {π}_{j}^{+} - {π}_{j}^{-} ) + {\sum }_{k = 1}^{K} {d}_{ik} {λ}_{k} \leq {α}_{i} , ∀ i = 1 , … , m$$
$${\sum }_{j = 1}^{n} ( {π}_{j}^{+} + {π}_{j}^{-} ) \leq P . \\ {λ}_{k} \geq 0 , {π}^{+} \geq 0 , {π}^{-} \geq 0.$$

20. The system of claim 17, wherein the dual linear program comprises:
$$DP 3 \text{:} Maximize {\sum }_{j = 1}^{n} {b}_{j} ( {π}_{j}^{+} - {π}_{j}^{-} ) + {\sum }_{k = 1}^{K} {e}_{k} {λ}_{k}$$
subject to:
$${\sum }_{j = 1}^{n} {a}_{ij} ( {π}_{j}^{+} - {π}_{j}^{-} ) + {\sum }_{k = 1}^{K} {d}_{ik} {λ}_{k} \leq {α}_{i} , ∀ i = 1 , … , m$$
$${\sum }_{j = 1}^{n} ( {π}_{j}^{+} + {π}_{j}^{-} ) \leq 1$$
$${π}_{j}^{+} \leq {w}_{j} , ∀ j = 1 , … , n . \\ {π}_{j}^{-} \leq {w}_{j} , ∀ j = 1 , … , n . \\ {λ}_{k} \geq 0 , {π}^{+} \geq 0 , {π}^{-} \geq 0.$$
